(19) United States
(12) Patent Application Publication
(10) Pub. No.: US 2006/0093765 A1
(43) Pub. Date: May 4, 2006

(54) Multi-compartment pouch having a frangible seal

(75) Inventor: Walter B. Mueller, Inman, SC (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Sealed Air Corporation (US)

(21) Appl. No.: 10/976,967

(22) Filed: Oct. 29, 2004

(51) Int. Cl. B32B 27/32

(52) U.S. Cl. 428/35.2

(57) ABSTRACT

The invention provides a pouch having a frangible seal comprised of two strips of thermoplastic material that are disposed in the interior of the pouch, and sealed to each other in a face-to face orientation. A first strip of thermoplastic material is sealed to an interior surface of one side of the pouch, and the second strip of thermoplastic material is sealed to an interior surface of the opposite side of the pouch. The strips of thermoplastic material are adapted to form stronger bonds with the front and rear sheets than they are with each other. As a result, the strength of the seal between the two strips of material may be controlled to produce a frangible seal that can be broken with minimal effort and without having to sacrifice the desired heat sealing properties of the film forming the pouch.

### BACKGROUND OF THE INVENTION

The invention relates generally to multi-compartment pouches, and more particularly to multi-compartments pouches having a frangible seal separating the compartments.

It is common practice to supply medical solutions for parenteral administration in the form of disposable, flexible pouches. One class of such pouches is commonly referred to as an “I.V. bag.” These pouches must meet a number of performance criteria, including collapsibility, optical clarity and transparency, high-temperature heat-resistance, and sufficient mechanical strength to withstand the rigors of the environment in which they are used. Medical solution pouches should also provide a sufficient barrier to the passage of moisture vapor and other gasses to prevent contamination of the solution contained therein.

In many cases, the medical solution delivered to the patient comprises a mixture of different components such as a diluent and one or more medicaments. Such mixtures are often stored separately to prevent instability of the drug mixture. Also, in some cases, some drugs may lose their efficacy when stored in a liquid diluent and are normally stored dry, typically as a powder.

Numerous IV bags have been developed that have multiple compartments for separately storing the medical components until they are mixed shortly before administration. Many currently available multi-compartment medical bags comprise two sheets that are heat sealed together around their perimeter and have a frangible seal dividing the interior of the medical bag into individual compartments. To produce a strong seal about the perimeter of the bag, the interior surfaces of the sheets typically comprise materials having good heat seal compatibility with each other. The perimeter and frangible heat seals must be able to withstand the high temperatures that are common to sterilization procedures, while still allowing the frangible seal to be easily broken.

In many bags, the frangible seals are also created by forming a heat seal in the interior of the bag. These medical bags typically strike a compromise between the sealability of the front and rear sheets and the strength of the frangible seal. As a result, the strength of the perimeter seal may be compromised to produce a frangible seal that can be easily broken. The force necessary to break the frangible seal is typically dependent upon the orientation of the seal, i.e., frangible seals produced in the longitudinal film direction typically have a different peel force than frangible seals produced in the transverse film direction. As a result, the frangible seal may be very difficult to break if the seal is not manipulated properly.

Thus, there exists a need for a multi-compartment bag having strong perimeter seals and strong frangible seals that may be easily broken at a desired time.

### BRIEF SUMMARY OF THE INVENTION

The invention comprises a multi-compartment pouch that is adeptly suited for storing and mixing medical solutions. The pouch comprises front and rear sheets that are joined together about their periphery to define a pouch having an interior space. A frangible seal separates the interior of the pouch into at least two compartments. The frangible seal comprises two strips of thermoplastic material that are disposed in the interior of the pouch. One of the strips of thermoplastic material is sealed to an interior surface of the front sheet and the other strip of thermoplastic material is sealed to an interior surface of the rear sheet. The strips are sealed to each other in a face-to face orientation to define two separate and distinct compartments in the pouch. The strips of thermoplastic material are adapted to form strong bonds with the front and rear sheets and to form a bond with each other that can be easily broken. As a result, the seal strength between the two strips of material can be controlled to produce a seal that can be broken with minimal effort without having to sacrifice the desirable heat sealing properties of the front and rear sheets.

In some embodiments, the frangible seal may be produced by using strips of thermoplastic material that form stronger bonds with the front or rear sheet than they do with each other. In other embodiments, the frangible seal may be produced by simultaneously applying heat to the opposite exterior surfaces of the pouch so that the strips bond to the interior surfaces of the pouch and to each other at substantially the same time. In this embodiment, the amount of heat can be controlled so that the level of heat reaching the interface of the two strips is less than the amount of heat sealing the strips to the pouch. As a result, it is possible to selectively control the strength of the frangible seal so that it can be designed to break easily yet still provide a seal which will not be broken unintentionally.

Thus, the invention provides a multi-compartment pouch having a frangible seal that can be adapted to have a desired level of strength without having to sacrifice the strength of the seal that joins the front and rear sheet together.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a multi-compartment pouch having a frangible seal;

FIG. 2 is a cross-sectional view of the multi-compartment pouch depicted in FIG. 1 viewed along line 2-2;

FIG. 3 is a perspective view of a multi-compartment pouch having a frangible seal and inlet ports for introducing components into the compartments;

FIG. 4 is a cross-sectional side view of the frangible seal depicted in FIG. 2;

FIG. 5 illustrates a cross-sectional view of an upper and lower heating element applying heat to the front and rear sheet to form heat seals between the sheets and the strips of thermoplastic material and a heat seal between the strips of thermoplastic material defining the frangible seal; and

FIGS. 6a through 6c are graphical illustrations depicting a user breaking the frangible seal and mixing the components contained within the pouch.

### DETAILED DESCRIPTION OF THE INVENTION

The invention now will be described more fully hereinafter with reference to the accompanying drawings, in which some, but not all embodiments of the invention is shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

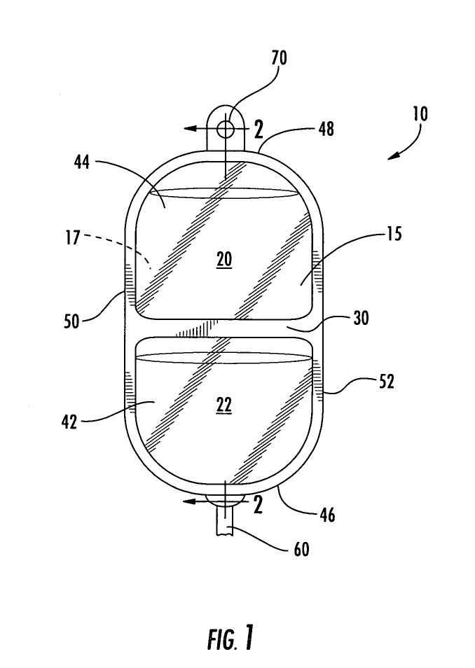

With reference to FIG. 1, a multi-compartment pouch in accordance with the invention is illustrated and broadly designated as reference number 10. As shown, the pouch comprises a container having at least one frangible seal 30 defining separate compartments 20, 22 adapted for separately confining components 42, 44 therein. At a desired time, the separated components can be mixed together by breaking the frangible seal 30. The separated components can include a variety of substances including, without limitation, solutions, suspensions, liquids, powders, and the like. In particular, the pouch is particularly useful for separately storing a liquid diluent and medicant. Typically, the frangible seal can be broken by physically manipulating the pouch. As used herein, the term frangible seal refers to a seal which is sufficiently durable to allow normal handling of the pouch yet which will peel or substantially separate under pressure applied by manipulating the pouch.

The pouch 10 may comprise a front sheet 15 and a rear sheet 17 that are oriented face-to-face and affixed to each other at side edges 50, 52, top edge 48, and bottom edge 46. Preferably, each of the edges are non-frangible and are permanently sealed and will not rupture by the pressures necessary to break the frangible seal. Typically, the seal strength for outer edges is about 40 N/in or greater as measured by ASTM test F88-00. In some embodiments, the front and rear sheets may comprise two separate sheets, or alternatively, a single sheet that has been center-folded at bottom edge 46. Together the sheets define pouch 10 having a plurality of interior compartments for receiving various components, such as solutions, powders, and the like. The front and rear sheets may be sealed together using adhesive, thermal bonds, ultrasonic bonds, radio frequency sealing, or the like. As used herein, the term “seal strength” refers to the force per unit width of film required to progressively separate two materials that have been sealed together.

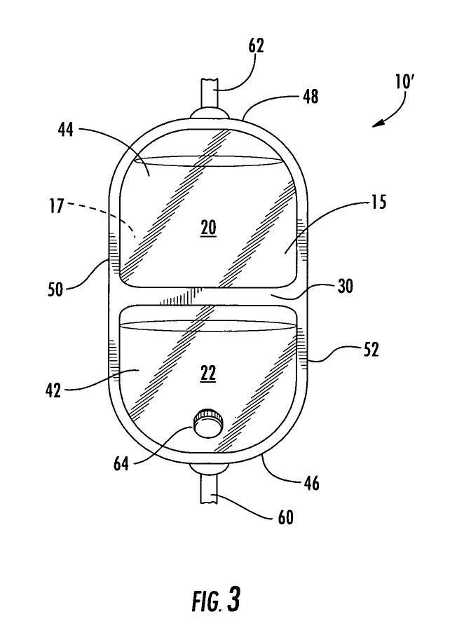

In some embodiments, the pouch may comprise a discharge outlet 60 that is adapted to be in fluid communication with compartment 22. The discharge outlet may be attachable to a standard IV device and/or administration set. The pouch may also comprise a support hole 70 or clip for attaching the pouch to a support such as stand. In one embodiment, the pouch may comprise one or more inlets for introducing the components that are to be confined within the pouch. In some embodiments, discharge outlet 60 may serve a dual role for introducing the components and releasing the components at a desired time. In this regard, FIG. 3 illustrates a pouch 10′ having a plurality of compartments 20, 22 for releasably confining a desired component therein. A first inlet port 62 is adapted to be in fluid communication with compartment 20, and discharge outlet 60 may function as a second inlet port. The inlet ports are adapted for providing a closeable opening through which components can be introduced into compartments 20, 22. In some embodiments, the pouch 10′ may also comprise one or more injection inlets 64 that are adapted to be in fluid communication with one of the compartments. The injection inlet 64 can be used to introduce additional components, such as a medicant, into a compartment.

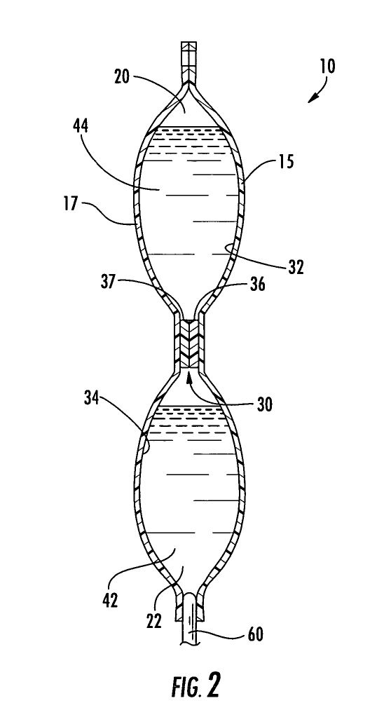

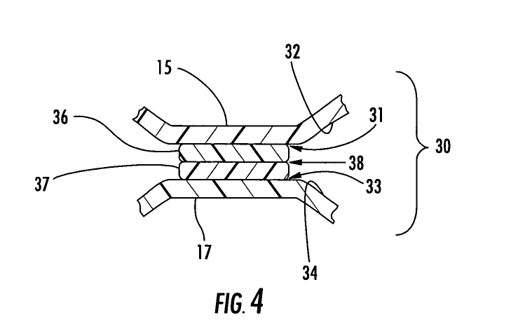

With reference to FIG. 2, a cross-sectional view of frangible seal 30 viewed along line 2-2 of FIG. 1 is illustrated. The frangible seal 30 may be produced by two strips of heat sealable material 36, 37 that are arranged in a face-to-face orientation with one strip 36 having a surface bonded to the interior surface 32 of the front sheet 15, and the other strip 37 having a surface bonded to the interior surface 34 of the rear sheet 17, and each strip having opposing surfaces that are attached to each other with a bond that may be easily broken to produce a frangible seal at 38 (see FIG. 4). As shown in FIG. 2, the resulting frangible seal 30 may be used to divide the pouch into at least two compartments. Preferably, the strips of heat sealable material extend from one side edge to an opposite side edge to define distinct compartments that are adapted to releasably confine a component, such as liquid or powder, therein. The strips of thermoplastic material are each typically from about 0.5 to 2 mil thick.

With reference to FIG. 4, frangible seal 30 is created from a first material 36 that is attached to an inner surface 32 of the front sheet 15 at 31 to thereby define a seal strength between the front sheet and the first thermoplastic material that is non-frangible, and a second material 37 attached to an inner surface 34 of the rear sheet 17 at 33 to thereby define a seal strength between the rear sheet and the second thermoplastic material that is non-frangible. The first and second materials are detachably sealed together at 38. As shown, the first and second materials 36, 37 are typically arranged in the interior of the pouch in a face-to-face orientation to produce a frangible seal therebetween. In some embodiments the frangible seal is formed from a partial melting together of the first and second materials. The quantity and placement of frangible seals contained in the pouch may be varied depending upon design preference and need.

The first and second materials 36, 37 typically comprise a thermoplastic film having a layer of thermoplastic material for bonding to an inner surface of either the front or rear sheet. As used herein, the term thermoplastic film includes both mono- and multi-layer films including coextruded films, sheets, webs, laminates, and the like having at least one surface that is capable of forming a heat seal with the front sheet 15 or rear sheet 17. In some embodiments, the thermoplastic films may also be crosslinked using various methods including electron beam, gamma beam, and chemically induced crosslinking. Suitable thermoplastic films should have good heat sealing or laminating compatibility with the front and rear sheets 15, 17 so that a strong seal or bond is created between the first material and front sheet, and the second material and rear sheet. Preferably, the seal or bond 38 between the first and second materials 36, 37 has a seal strength that is less than the seal strength of bonds 31 or 33. As a result, the force necessary to break the frangible seal at 38 is less than the force necessary to separate either the front sheet 15 from the first material 36, or the rear sheet 17 from the second material 37. The first and second materials may comprise different materials or may be the same.

In some embodiments, the first and second materials 36, 37 may comprise a film having at least two layers that are adapted for bonding with either the inner surface of the pouch or with an opposing layer of the opposite thermoplastic material. For example, the first and second thermoplastic materials may each include a first layer that is capable of forming a strong bond with the front and rear sheet, respectively, and a second layer that is adapted to seal with the second layer of the opposing thermoplastic material to define a frangible seal therebetween. In some embodiments, the front and rear sheets and the first layer of the thermoplastic material may be comprised of the same material.

In some embodiments, the first and second thermoplastic materials comprise thermoplastic films selected from ethylene homopolymer, ethylene copolymer, propylene homopolymer, propylene homopolymer, propylene copolymers, and blends thereof. In one embodiment, the first and second materials comprise a blend ethylene copolymer and ethylene copolymer. Suitable ethylene copolymers include ethylene/alpha-olefin copolymers. The term “ethylene/alpha-olefin copolymer” generally designates copolymers of ethylene with one or more comonomers selected from C₃ to C₂₀ alpha-olefins, such as 1-butene, 1-pentene, 1-hexene, 1-octene, methyl pentene and the like, in which the polymer molecules comprise long chains with relatively few side chain branches. A more in depth description of ethylene/alpha-olefin copolymer is contained in U.S. Pat. Nos. 5,695,840 and 6,027,776, the contents of which are hereby incorporated by reference. In one embodiment, the amount of propylene ethylene copolymer present in the blend may be in the range of about 60 to 95 percent by weight and the amount of ethylene/alpha-olefin copolymer may in the range of about 5 to 40 percent by weight.

In some embodiments, the first and second materials may also include elastomers. The term “elastomer” refers generally to a material that, at room temperature, can be stretched repeatedly to at least twice its original length. This characteristic distinguishes plastics from elastomers and rubbers, as well as the fact that elastomers are given their final properties by mastication with fillers, processing aids, antioxidants, curing agents, etc., followed by vulcanization (curing) at elevated temperatures. However, a few elastomers are thermoplastic. Such thermoplastic elastomers include the following preferred materials: styrene-ethylene-butylene-styrene copolymer (SEBS), styrene-butadiene-styrene copolymer (SBS), styrene-isoprene-styrene copolymer (SIS), ethylene-propylene rubber (EPM), and ethylene-propylene-diene terpolymer (EPDM).

Using separate materials to create the frangible seal rather than creating the frangible seal by direct attachment of the front and rear sheets together may provide many advantages. The separately attached strips help to control the resulting properties of the frangible seal without having to compromise film properties that are associated with the front and rear sheets, such as perimeter seal strength, optical properties, stiffness, and the like. As a result, a frangible seal can be produced that can be designed to withstand high sterilization temperatures, while still allowing the frangible seal to be easily broken without having to compromise the strength of the bond between the front and rear sheets. In addition, as discussed below, the resulting frangible seal properties can be controlled by material selection and the amount heat that is applied to produce the frangible seal.

To be useful in medical applications, frangible seal 30 should be able to withstand the high temperatures that are necessary for sterilization, while still allowing the frangible seal to be easily broken at a desired time. As discussed above, the use of separate strips of thermoplastic materials allows the strength of the frangible seal to be controlled so that the seal will better withstand conditions that are commonly associated with the sterilization, distribution, and storage of the filled pouch.

The frangible seal may be created in several ways that may be used separately or in combination to produce a frangible seal at the interface of the first material 36 and the second material 37. In some embodiments, the first and second materials 36, 37 may be less compatible for attachment to each other than they are to the front or rear sheets 15, 17. For example, in some embodiments the first material 36 and the second material may weakly bond to each other while at the same time forming a strong bond with the front or rear sheet. As a result, the frangible seal at 38 will be weaker than seals 31 or 33. In some embodiments, the frangible seal may be created by applying less heat at the interface of the first and second materials 36, 37 than is applied at the interfaces between the front sheet and the first material, and the rear sheet and the second material. Selectively varying the amount of heat applied at interface 38 allows the strength of the heat seal to be designed to have a desired strength. In addition, the thermoplastic materials used and the amount heat used to make the frangible seal may be controlled in conjunction to produce a frangible seal having a desired strength.

Frangible seals prepared in accordance with the invention are not prepared by sealing the front and rear sheets directly together, and are not typically dependent upon the direction in which the seals are formed, for example, machine or transverse direction. As a result, the force necessary to break the frangible seal 30 should be relatively constant regardless of the position or orientation of the seal.

In one embodiment, the pouch 10 comprises a container or pouch having a bag-like shape. Alternatively, the pouch 10 may have a bottle-like, tray-like, box-like, or tube-like shape. The shape and size of the pouch may be varied depending upon its intended use and need.

The pouch 10 of the present invention may be prepared from a variety of suitable plastic materials whereby a strong, lightweight, reliable, yet economic container is provided. Preferably, each sheet comprises a plastic material having an inner surface capable of forming a strong heat seal with the inner surface of the opposite sheet to define the pouch. Suitable plastic materials include both multi- and mono-layered films, webs, laminates, and the like.

In some embodiments, the pouch may comprise a suitable elastomeric material, such as olefin-based materials, including but not limited to, polyethylene, propylene ethylene copolymers, ethylene-vinyl acetate copolymers, ethylene-acrylic ester copolymers, iononomers, and combinations thereof. Additionally, film layers comprising polymers having barrier properties, such as polyvinylidene chloride and ethylene-vinyl alcohol copolymers, as well as film layers of such polymers as polyvinyl chloride, polyester, polyamide, and polyurethanes may also be used. The pouch may also comprise any flexible material, including, polypropylene film, polyethylene film, plasticized polyvinyl chloride film, plasticized polyvinylidene chloride film, polyethylene/ethylene-vinyl acetate copolymer laminate, ethylene-vinyl acetate copolymer/polyvinylidene chloride/ethylene-vinyl acetate copolymer laminate, and polyethylene/ethylene-vinyl acetate copolymer/polyethylene chloride/ethylene-vinyl acetate copolymer/polyethylene laminate, among others.

Preferably, pouches for use in the medical field are prepared from films or laminates that can withstand the high-temperature sterilization and storage conditions that are commonly associated with medical solutions and powders. Particularly useful films for medical pouches are described in U.S. Pat. Nos. 5,695,840 and 6,027,776.

The pouch may be prepared in a variety of ways. In one embodiment, the pouch may be prepared from a roll of double-wound film wherein the sheets are separated to form the front and rear sheets of the pouch. The separate sheets may then be conveyed in a substantially parallel manner. In other embodiments, the front and rear sheets may be formed from a tubular film or from sheets of film that are provided on separate supply rolls. In some embodiments, any excess sheet material can be trimmed away from around the perimeter heat seals. If desired, the front or rear sheets may be printed with any necessary labeling information.

Once the sheets are separated, the first and second materials defining the frangible seal may be placed between the sheets in a face-to-face orientation. The first and second materials may comprise separate strips of film or may be a single strip of film that has been center-folded to define the first and second materials. It should be recognized that the first and second strips of material may be arranged in numerous different configurations depending upon factors such as the desired number of compartments, design, and need.

The side edges of the pouch may then be sealed together to define the pouch. Typically, a portion of the pouch's perimeter, such as the top and bottom edges may remain unsealed for receiving one or more inlet or discharge outlets. The temperature at which the edges of the pouch are bonded together is preferably determined by the particular material used and the desired strength of the seal. At the same time, or in a previous or subsequent step, the first and second materials may be bonded to the front and rear sheets to form the frangible seal.

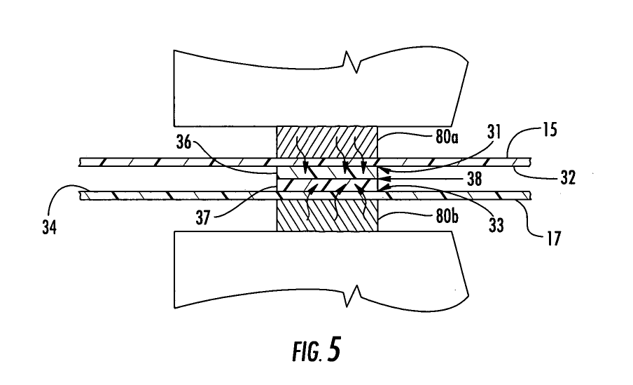

In some embodiments, the first and second materials may be bonded to the front and rear sheet at substantially the same time. In this regard, FIG. 5 illustrates an upper heating element 80a that is being used to bond the first material 36 to the front sheet 15, and a lower heating element 80b that is used to bond the second material 37 to the rear sheet 17. As shown, heat from both heating elements (represented by the small wavy arrows) passes through the front and rear sheets and into the first and second materials to produce a strong heat seal at 31 and 33. The heat continues to pass through the first and second materials and forms a seal at the interface 38 of the first and second materials. The heat normally dissipates as it passes through the first and second materials resulting in a decrease in the amount of heat to which the interface at 38 is exposed. As a result, the surfaces of the first and second materials at interface 38 may be melted or softened to a lesser extent than the film surfaces at 31 or 33. This may result in creating a heat seal at 38 having a lower seal strength than the heat seals created at 31 or 33. The strength of the seal at 38 may be lowered or decreased by altering the temperature of the heated elements or by varying the dwell time to which the materials are exposed to the heating elements. As a result, the strength of the frangible seal can be controlled to produce a heat seal having a desired strength. As discussed above, the strength of the frangible seal can also be controlled by selecting first and second materials that form stronger bonds with the front and rear sheets than they do with each other.

Once the frangible seal is formed the periphery edges of the pouch can be sealed. In some embodiments, the pouch may include inlet ports through which desired substances, such as medicants, solution, powders, and the like can be introduced into the compartments. The discharge and inlet outlets may be joined to the pouch before or after the edges of the pouch have been sealed. A heat seal can be used to secure the discharge and inlet outlets to the pouch. After filling with a desired substance, the ports can sealed to the outside atmosphere by means of a cap or closure.

After the pouch has been manufactured, sealed, and filled, it is ready for sterilization. Autoclaving is a method that is commonly used for sterilizing medical liquids and equipment. In one technique, the sterilized pouch is placed into a plastic overwrap or container. The overwrap may serve as a dust cover and help protect the contents of the pouch from any external foreign contaminants, moisture loss, gas permeation, etc. If desired, the sterilization process could be performed following the overwrapping process. Additionally, depending upon the product requirements, one compartment can be filled and sterilized first, followed by the filling, sealing, and sterilization of the other compartment.

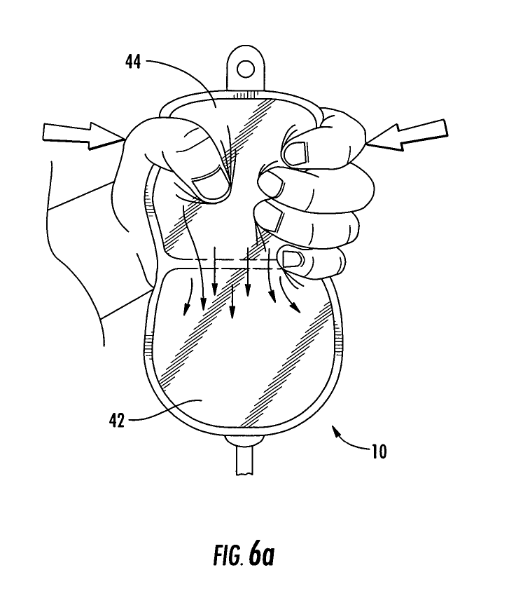

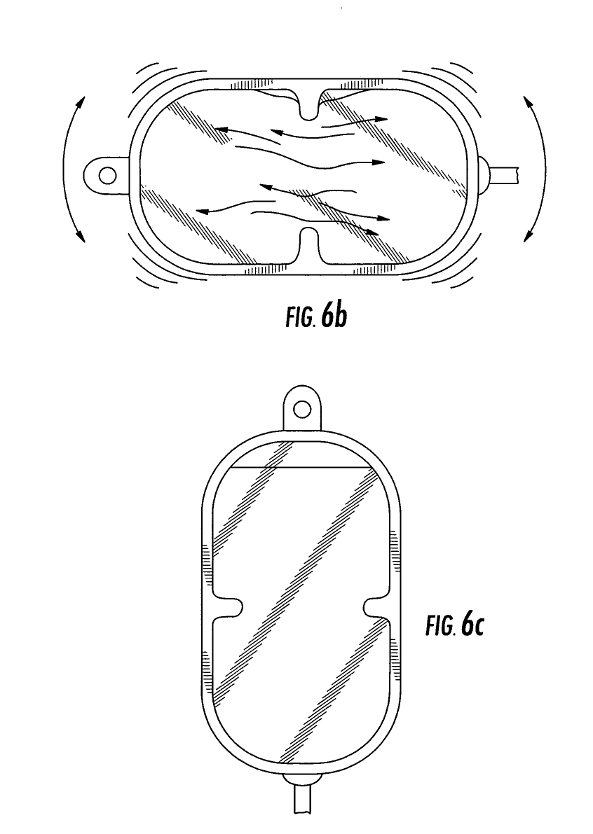

When it is desirable to use the filled pouch and intermix the separated components, a squeezing action or any similar force onto the pouch's walls will cause the frangible seal to break. In this regard, FIGS. 6a through 6c illustrate a pouch 10 having a frangible seal that is broken by applying manual pressure to the pouch to rupture the seal. As shown in FIG. 5a, the seal may be broken by applying a squeezing action that results in components 42 or 44 exerting pressure against the frangible seal. In FIG. 6b the previously separated components are mixed to together in the pouch to allow free flow of the two materials in the pouch. After thorough mixing, the contents of the pouch are ready to be dispensed (see FIG. 6c).

It should be evident from the preceding discussion, that the invention provides a flexible container for separately storing materials that can be easily fabricated and readily utilized to mix separately stored components. The frangible seal may be designed so that it can withstand the rigorous conditions associated with sterilization and use, and still be easily activated with a minimum amount of effort at a desired time. The pouch can be molded in various configurations to be adapted to numerous types of applications.

### EXAMPLES

The following examples are provided for the purpose of illustration and should not be considered as limiting the invention in any way.

In the following examples, several pouches were prepared by heat sealing two sheets of a multi-layered film together to define a pouch. The multi-layered pouch was prepared from a five layered film having the following construction:
1) inner (sealant) Modified Propylene/ethylene copolymer;
2) Layer 2 Adhesive;
3) Layer 3 Polyethylene;
4) Layer 4 Adhesive; and
5) Layer 5 Copolyester.
   Each pouch includes a frangible seal that is formed from sealing two strips of thermoplastic material to the each other in a face-to-face orientation and sealing the strips to the interior sides of the pouch to form two separate compartments. Seal strengths in the following examples were measured with ASTM test F88-00.

The frangible seal was formed from a thermoplastic film comprising about 90 percent by weight propylene ethylene copolymer and about 10 percent by weight linear low density ethylene (LLDPE). The film was crosslinked with an electronic crosslinking unit to a level of 1.5 megarads. The thermoplastic film was cut into strips that were about 4.5″ in length by about 0.5″ in width. The strips were placed between the sheets in a substantially face-to-face orientation and sealed with a modified Vertrod sealer having dual 12″ hot seal bars. The heated seal bars were applied to the front and rear sheets opposite each other at a pressure of about 25 pounds per linear inch of seal bar (PLI), and at temperatures of 117, 119, and 121° C. for a dwell time of 2 seconds.

The perimeter of the sheets were sealed together using an Alloyd press equipped with 1-liter seal jaws. The perimeter edges of the sheets were sealed together at 196° C. at a cylinder pressure of 50 psi and a dwell time of about 2.5 seconds. A connector tubing was inserted and sealed into each end of the pouch with a multiple station turntable press. The connector tubing was sealed at 188° C. at a cylinder pressure of 50 psi and a dwell time of about 2 seconds. The connector tubing comprised a polymeric material formed from a three layer coextrusion having an outer (sealant) comprising modified propylene/ethylene copolymer, an inner layer comprising an adhesive, and a third layer comprising ethylene/vinyl acetate (EVA).

Each compartment of the pouch was then filled with 250 mm of water and sealed closed. A food coloring additive was added to one side of the pouch to determine if any leakage occurred during the filling or sterilization process. The filled pouches were then overwrapped in a polypropylene overwrap material and sterilized for 20 minutes at 121° C. After sterilization, the pouches were allowed to cool to room temperature for 24 hours. The pouches were then inspected. None of the frangible seals showed any signs of failure or leakage between the two compartments. The pouches were then drained and the frangible seal portion of the pouch was cut into 3 one inch strips and tested on an Instron tensile tester. The results are summarized below in Tables 1 and 2.

TABLE 1
Frangible Seal Strength

| | Film gauge | Sealing temperature | Strength** |
|---|---|---|---|
| | mil | (C.) | (N/in.) |
| Sample 1* | 0.75 | 117 | 9.3 |
| Sample 2* | 0.75 | 119 | 10.8 |
| Sample 3* | 0.75 | 121 | 11.1 |
| Sample 4* | 1 | 117 | 10.6 |
| Sample 5* | 1 | 119 | 16.3 |
| Sample 6* | 1 | 121 | 18.2 |

*Each thermoplastic film strip comprises 90 percent by weight propylene ethylene copolymer and 10 percent by weight linear low density ethylene (LLDPE).
**Seal Strength was measured with ASTM test F88-00.

TABLE 2
Frangible Seal Strength After Autoclaving

| | Material thickness | Sealing temperature | Strength** |
|---|---|---|---|
| | (mil) | (C.) | (N/in.) |
| Sample 1* | 0.75 | 117 | 9.3 |
| Sample 2* | 0.75 | 119 | 10.8 |
| Sample 3* | 0.75 | 121 | 11.1 |
| Sample 4* | 1 | 117 | 8.9 |
| Sample 5* | 1 | 119 | 14.3 |
| Sample 6* | 1 | 121 | 17.0 |

*Each strip comprises 90 percent by weight propylene ethylene copolymer and 10 percent by weight linear low density ethylene (LLDPE).
**Seal Strength was measured with ASTM test F88-00.

Generally, seal strengths in the range of about 5 to 30 N/inch are considered adequate for pouches that are used in medical applications, with seal strengths of about 10 to 25 N/inch being somewhat more typical. Seal strengths below 10 N/inch may be used, although not necessarily with equivalent results. As should be evident from the foregoing tables, the strength of the frangible seal can be controlled by various factors including the temperature used to form the seal, thickness of the film, or material from which the seal forming films are comprised. It should also be noted that the resulting properties of the frangible seal can be selectively controlled without having to sacrifice the desired properties of the front and rear sheets.

In the following example, 15 pouches were prepared wherein each pouch has a frangible seal that was formed at either 119 or 121° C. Strips of 1 mil gauge film were used for creating the frangible seal. The force necessary to break the frangible seal was rated subjectively on a scale of 1 to 5, with 1 being unacceptable and 5 being unable to open. A rating of 2 to 3 is considered an acceptable amount of force to activate (break) the frangible seal. After the seals were activated, the pouch was rolled side-to-side to fully open the seal and determine if the front and rear sheets were damaged in any way. No such damage was observed.

TABLE 3
Frangible seal ease of breakability

Seal Temperature

| | 119° C. | 121° C. |
|---|---|---|
| Score | 3 | 3 |
| | 2 | 3 |
| | 2.5 | 3 |
| | 3 | 3 |
| | 3 | 3 |
| | 3 | |
| | 3 | |
| | 3 | |
| | 3 | |
| | 1.5 | |
| Average Score | 2.7 | 3 |

Many modifications and other embodiments of the invention set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A multi-compartment pouch comprising:
front and rear sheets arranged in opposing face-to-face relation and each including a top edge, a bottom edge, and opposite side edges adapted to be connected to define a sealed pouch with an interior; and
at least one frangible seal disposed in the interior of the pouch between said front and rear sheets and defining at least two separate compartments, said frangible seal comprising a first thermoplastic material attached to said front sheet and a second thermoplastic material attached to said rear sheet, said first and second materials arranged in opposing face-to-face relation across the interior of the pouch and attached to one another to define a frangible seal therebetween, said frangible seal having a seal strength that is less than the seal strength of the first material to the front sheet and the second material to the rear sheet.

2. The multi-compartment pouch according to claim 1, wherein the front and rear sheet comprise a flexible thermoplastic material.

3. The multi-compartment pouch according to claim 1, wherein the top edges, bottom edges, and opposite side edges of the front and rear sheets are connected to define a sealed pouch and wherein said edges are affixed to each other with an adhesive, thermal bond, radio frequency bond, or ultrasonic fusion bond.

4. The multi-compartment pouch according to claim 1, wherein said front and rear sheets are interconnected along said bottom edge by a fold line, and are interconnected along the top edge and opposite side edges by bonds.

5. The multi-compartment pouch according to claim 1, wherein the first and second materials comprise the same material.

6. The multi-compartment pouch according to claim 1, wherein the first and second thermoplastic materials include materials selected from the group consisting of ethylene homopolymer, ethylene copolymer, propylene homopolymer, propylene homopolymer, propylene copolymers, and blends thereof.

7. The multi-compartment pouch according to claim 6, wherein said first and second materials comprise a blend of ethylene copolymer and propylene copolymer.

8. The multi-compartment pouch according to claim 7, wherein said ethylene copolymer comprises an ethylene/alpha-olefin copolymer and said propylene copolymer comprises a propylene/ethylene copolymer.

9. The multi-compartment pouch according to claim 8, wherein said propylene/ethylene copolymer is present in said blend at a weight percentage ranging from about 60 to 95 percent and said ethylene/alpha-olefin copolymer is present in said blend in a weight percentage ranging from about 5 to 40 percent.

10. The multi-compartment pouch according to claim 1, wherein the pouch further comprises at least one discharge outlet in fluid communication with one of said compartments.

11. The multi-compartment pouch according to claim 1, wherein the pouch further comprises at least one first inlet port adapted for fluid communication with one of said compartments, and at least one second inlet port adapted for fluid communication with a second compartment.

12. The multi-compartment pouch according to claim 1, wherein the pouch further comprises at least one injection inlet adapted to be in fluid communication with one of said compartments.

13. The multi-compartment pouch according to claim 7, wherein the first and second material are heat sealed together, said heat seal having a seal strength from about 5 to 30 N/inch.

14. The multi-compartment pouch according to claim 1, wherein the first material is attached to the front sheet with a heat seal, and second material is attached to the rear sheet with a heat seal.

15. A multi-compartment pouch comprising:
front and rear sheets arranged in opposing face-to-face relation and each including a top edge, a bottom edge, and opposite side edges connected to define a sealed pouch with an interior; and
at least one frangible seal disposed in the interior of the pouch between said front and rear sheets and defining at least two separate sealed compartments, said frangible seal comprising a first thermoplastic material attached to said front sheet and a second thermoplastic material attached to said rear sheet, said first and second materials arranged in opposing face-to-face relation across the interior of the pouch and defining a frangible seal therebetween, said frangible seal having a seal strength that is less than the seal strength of the first material to the front sheet and the second material to the rear sheet.

16. The multi-compartment pouch according to claim 15, wherein the first and second materials each comprise a film having first and second layers, wherein the first layers of said first and second materials are sealed to said front and rear sheets, respectively, and the second layers of said first and second materials are sealed to each other to produce the frangible seal therebetween.

17. The multi-compartment pouch according to claim 16, wherein the front sheet, rear sheet, and the first film layers of said first and second materials comprise the same material.

18. The multi-compartment pouch according to claim 15, wherein said first and second materials comprise a blend of ethylene copolymer and propylene copolymer.

19. The multi-compartment pouch according to claim 18, wherein the first and second materials comprise a blend of about 60 to 95 percent propylene/ethylene copolymer and about 5 to 40 percent ethylene/alpha-olefin copolymer.

20. The multi-compartment pouch according to claim 15, wherein the first and second materials comprise a thermoplastic film comprising a blend of propylene ethylene copolymer and an elastomer.

21. The multi-compartment pouch according to claim 15, wherein the pouch further comprises at least one discharge outlet in fluid communication with one of said compartments, and at least one inlet port adapted for fluid communication with a second compartment.

22. The multi-compartment pouch according to claim 15, wherein the first and second material are heat sealed together, said heat seal having a seal strength from about 5 to 30 N/inch.

23. The multi-compartment pouch according to claim 15, wherein the pouch comprises a first compartment having a diluent, and a second compartment having a medicant.

24. The multi-compartment pouch according to claim 23, wherein the medicant is selected from a powder, solution, suspension, and liquid.

25. A method of preparing a multi-compartment pouch comprising the steps of:
providing a front sheet and rear sheet comprising a heat sealable film;
arranging said sheets in a face-to-face orientation to define a pouch having two opposite side edges, bottom edge, and top edge;
placing first and second strips of thermoplastic material in a substantially face-to-face orientation between said sheets to define at least two compartments;
sealing the first material to the front sheet, and the second material to the rear sheet;
forming at least one frangible seal between the first and second materials, said frangible seal having a seal strength that is less than the seal strength of the seal between the first material and the front sheet, and the second material and rear sheet; and
sealing the front and rear sheet together about the periphery of the pouch.

26. The method according to claim 25, wherein the steps sealing the first material to the front sheet, sealing the second material to the rear sheet, and forming the frangible seal further comprises the step of:
contacting the exterior surfaces of the front and rear sheet with a pair of heating elements, whereby heat from said heating elements seals the first material to the front sheet and the second material to the rear sheet, and the first and second materials to each other.

27. The method according to claim 25, wherein the step of providing a front sheet and rear sheet further comprises the step of supplying said front and rear sheet from a roll of double wound film.

28. The method according to claim 25, further comprising the step of joining one or more inlets to said pouch, wherein at least one of said inlets is adapted to be in fluid communication with one of said at least two compartments and a second inlet is adapted to be in fluid communication with a second compartment.

29. The method according to claim 25, further comprising the step of introducing a substance into at least one of said compartments.

30. The method according to claim 29, further comprising sterilizing the pouch and the substance contained therein.

31. The method according to claim 29, further comprising the step of rupturing the frangible seal to mix the substances contained therein.

32. The method according to claim 29, wherein the step of introducing a desired material into each compartment further includes the steps of introducing a diluent into at least one compartment, and a medicant into a separate compartment.
